(19) United States
(12) Patent Application Publication
(10) Pub. No.: US 2002/0011159 A1
(43) Pub. Date: Jan. 31, 2002

(54) Screen printing plate, method for making it and screen printing method

(75) Inventor: Naokazu Mazaki, Aiko-gun (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Asahi Glass Company, Limited, Chiyoda-ku (JP)

(21) Appl. No.: 09/835,383

(22) Filed: Apr. 17, 2001

(30) Foreign Application Priority Data
Apr. 19, 2000 (JP) 2000-117597

(51) Int. Cl. B05C 17/06; B41C 1/14; B41M 1/12

(52) U.S. Cl. 101/127; 101/128.4; 101/129

(57) ABSTRACT

A screen printing plate made to carry out printing along a peripheral portion of a plate substrate, which screen printing plate has a fine pattern at a region corresponding to a desired width ranging from slightly outside of a flat surface end of the plate substrate to a flat surface inside of the flat surface end, wherein an emulsion layer at the fine pattern is formed to have a higher oil repellency against ink on the surface on the plate substrate side than the oil repellency against ink on the surface on the squeegee side.

The present invention relates to a screen printing plate, a method for making it and a screen printing method.

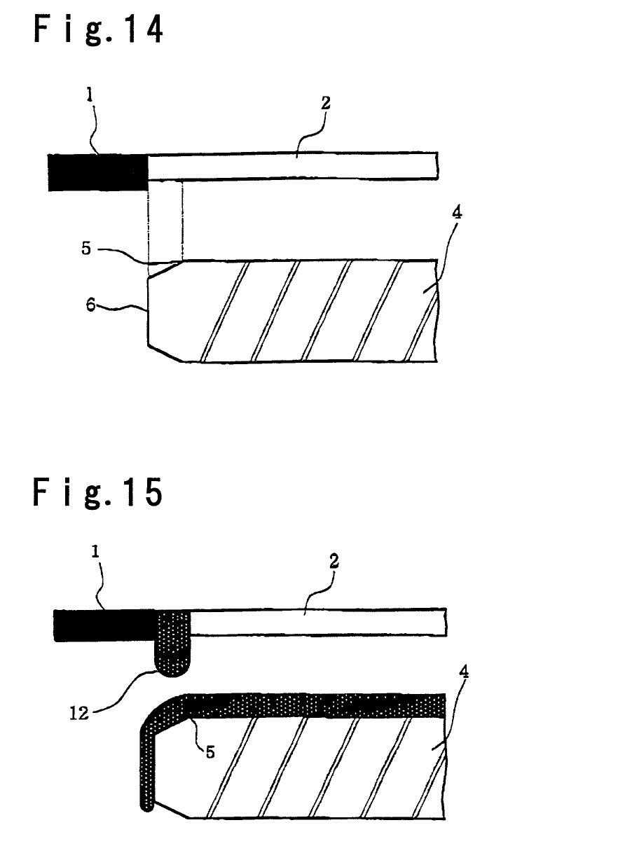

In flat glass such as window glass for an automobile like a windshield or rear window glass of an automobile, it has been heretofore common that a screen printed layer so-called “black ceramics” is formed along a peripheral portion of such flat glass for various purposes. In such flat glass, in order to form a printed layer certainly with a desired width extending to its flat surface end, as shown in FIG. 14, if irregularities in the outer shape, etc. of flat glass 4 are taken into consideration, the printing pattern (the ink-permeable region) 2 of a screen printing plate 1 is required to be set slightly larger than the flat surface end 5 of the flat glass 4.

If printing is carried out by the above-mentioned conventional screen printing, as shown in FIG. 15, ink 12 not transferred to the flat glass 4 will be pushed out and pooled on the rear (substrate side) surface of the screen printing plate 1 outside of the flat surface end 5 of the flat glass 4, and as the printing is repeated, the pooled ink 12 is likely to drip onto and stain the flat glass 4 during printing. Accordingly, in the prior art, there has been known a method wherein the printing pattern is divided and printed in a plurality of separated steps (JP-A-4-279382), a method wherein printing is carried out on flat glass having a larger outer shape than the printing pattern, and then the flat glass is cut into the predetermined outer shape (JP-A-5-70164), a method wherein masking is preliminarily applied along the circumference of flat glass, and printing is then carried out with a pattern larger than the outer shape of the flat glass, whereupon the masking is removed (JP-A-5-70179), or a method wherein printing is carried out with a pattern larger than the outer shape of flat glass, and then the ink pushed out on the rear surface of the screen printing plate, is removed by air pressure (JP-A-5-70180).

However, either one of such conventional methods has had many problems, such that printing steps and accompanying steps will increase, a special installation will be required, and the printed quality of flat glass is not consistent.

Accordingly, a first object of the present invention is to provide a screen printing plate, whereby printing can easily be carried out extending to the flat surface end of a plate substrate without the above-described drawbacks of the prior art, for example, without the problem of dripping of ink during the printing, and a method for making such a screen printing plate and a screen printing method. A second object is to provide such a screen printing plate free from the problem of dripping of ink over a long period of time, and a method for making such a screen printing plate and a screen printing method. A third object is to provide a screen printing plate, whereby printing can be carried out to the flat surface end of a plate substrate without a problem of mackling during the printing, and a method for making such a screen printing plate and a screen printing method. A fourth object is to provide a screen printing plate, whereby printing can easily be carried out to the flat surface end without dripping of ink, even in a case where the above flat surface end is a flat surface end at a through-hole formed in a plate substrate (particularly, a screen printing plate whereby printing can be carried out with a consistent quality, more particularly, a screen printing plate free from mackling), and a method for making such a screen printing plate and a screen printing method.

The present invention provides a screen printing plate made to carry out printing along a peripheral portion of a plate substrate, which screen printing plate has a fine pattern at a region corresponding to a desired width ranging from slightly outside of a flat surface end of the plate substrate to a flat surface inside of the flat surface end, wherein an emulsion layer at the fine pattern is formed to have a higher oil repellency against ink on the surface on the plate substrate side than the oil repellency against ink on the surface on the squeegee side, a method for making such a screen printing plate, and a printing method employing such a screen printing plate.

Further, the present invention provides a screen printing plate made to carry out printing along a peripheral portion of a through-hole of a plate substrate having such a through-hole within a flat surface, which screen printing plate has a fine pattern at a region corresponding to a desired width ranging from slightly the hole center side of a flat surface end of the plate substrate to a flat surface on the side opposite to the hole center of the flat surface end, wherein an emulsion layer at the fine pattern is formed to have a higher oil repellency against ink on the surface on the plate substrate side than the oil repellency against ink on the surface on the squeegee side, a method for making such a screen printing plate, and a printing method employing such a screen printing plate.

In the accompanying drawings:

FIG. 1 is a plan view showing one embodiment of the present invention.

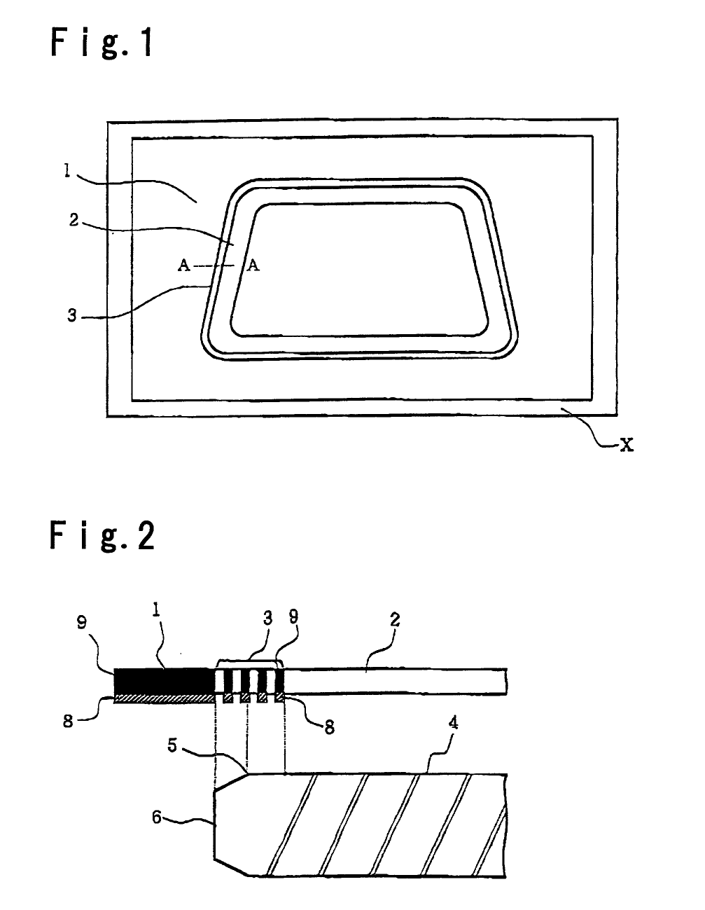

FIG. 2 is an enlarged cross-sectional view taken along line A-A in FIG. 1.

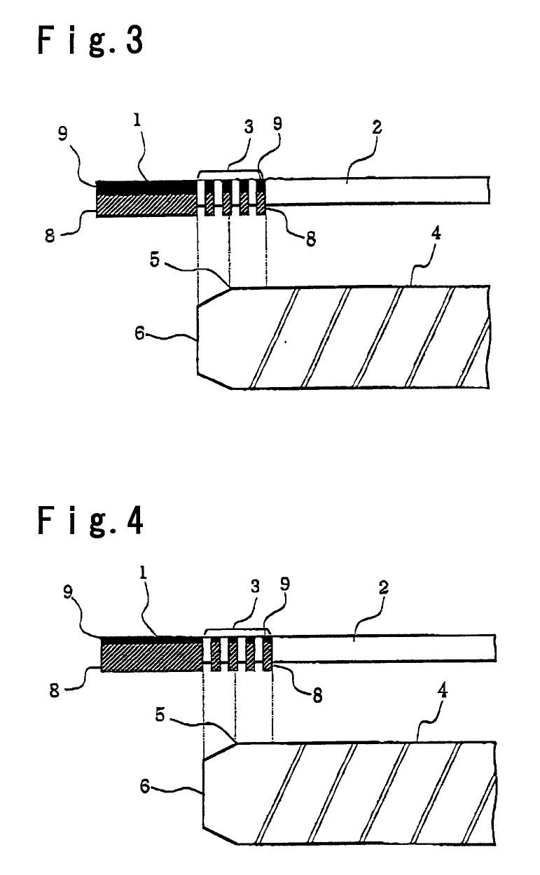

FIG. 3 is an enlarged cross-sectional view taken along line A-A of another embodiment of FIG. 1.

FIG. 4 is an enlarged cross-sectional view taken along line A-A of still another embodiment of FIG. 1.

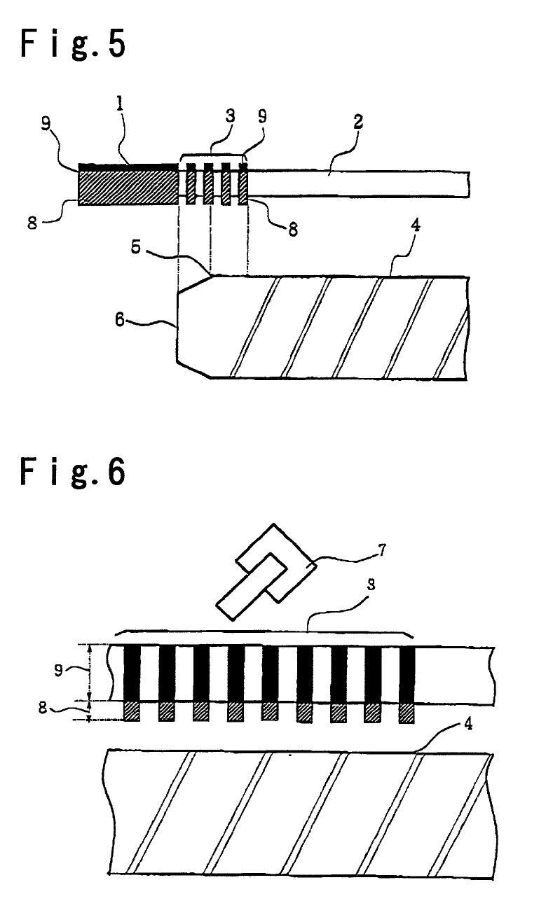

FIG. 5 is an enlarged cross-sectional view taken along line A-A of further another embodiment of FIG. 1.

FIG. 6 is an enlarged cross-sectional view of a part of FIG. 2.

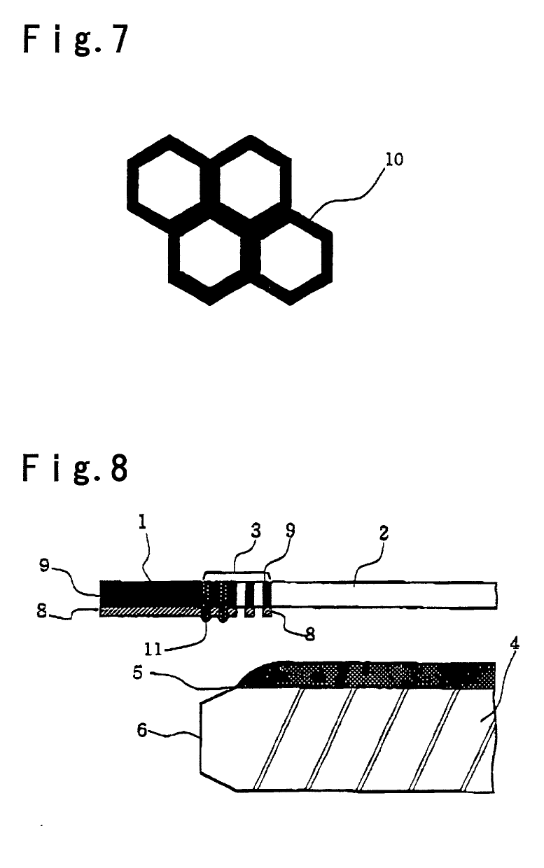

FIG. 7 is an enlarged plan view of a part of FIG. 6.

FIG. 8 is an enlarged cross-sectional view taken along line A-A in FIG. 1 to describe the effects of the present invention.

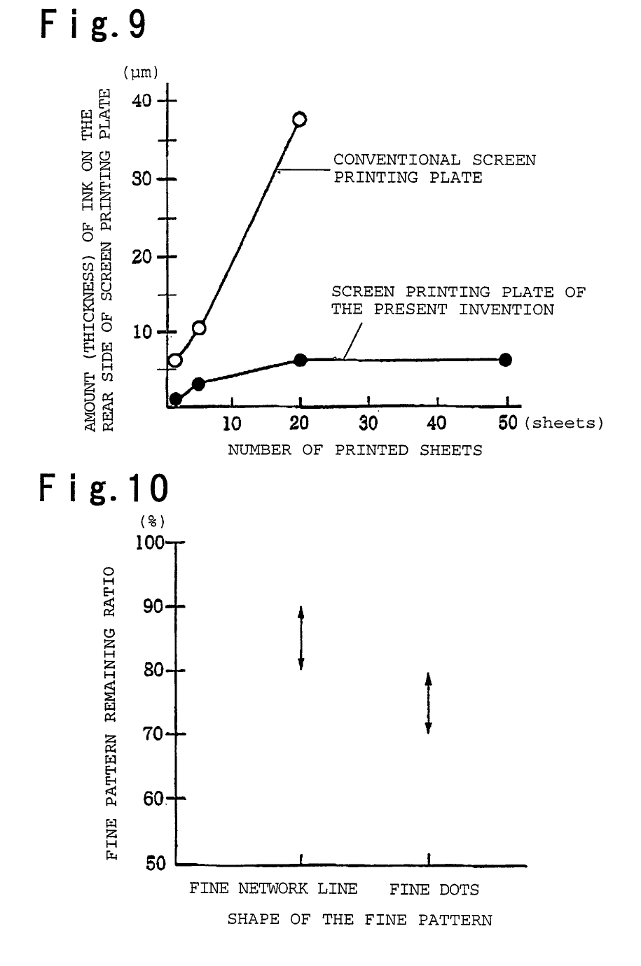

FIG. 9 is a graph showing the relation between the number of printed sheets and the amount (thickness) of ink on the rear side of the screen printing plate.

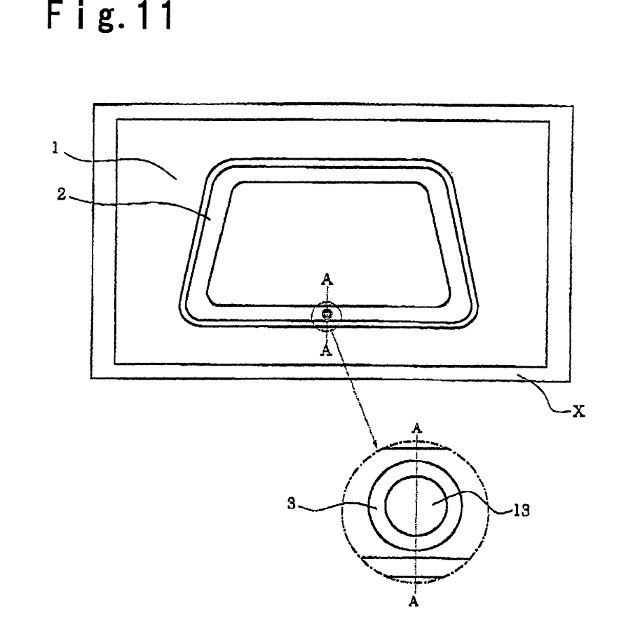

FIG. 10 is a graph showing the relation between the shape of the fine pattern and the fine pattern-remaining ratio.

FIG. 11 is a plan view showing another embodiment of the present invention.

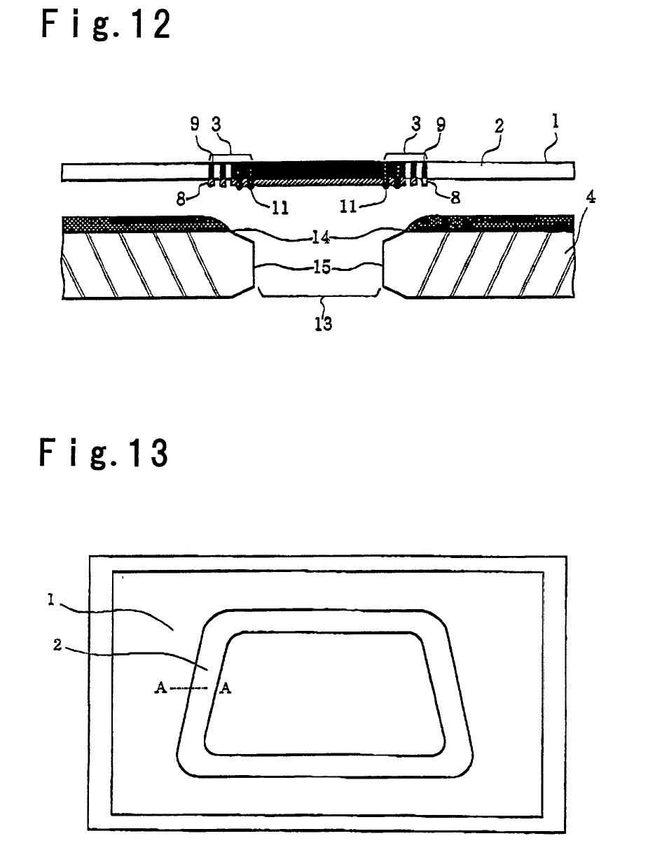

FIG. 12 is an enlarged cross-sectional view taken along line A-A in FIG. 11.

FIG. 13 is a plan view to illustrate the prior art.

FIG. 14 is an enlarged cross-sectional view taken along line A-A in FIG. 13.

FIG. 15 is an enlarged cross-sectional view taken along line A-A in FIG. 13 to describe the effects of the prior art.

Now, the present invention will be described in detail with reference to the preferred embodiments.

FIG. 1 is a plan view of the basic structure of the screen printing plate of the present invention, and FIG. 2 is an enlarged cross-sectional view along line A-A in FIG. 1 showing the state before printing. In the Figures, X is a frame of the screen printing plate, and numeral 1 is a screen mesh made of e.g. a Tetron (polyester) fibers, provided within the frame X. Such a screen mesh 1 is usually from 90 to 380 mesh, for example, 180 mesh. Numeral 2 indicates a printing pattern made to have a desired width inside of the flat surface end 5 of a plate substrate 4 such as a windshield or a rear window glass of an automobile, and numeral 3 indicates a pattern made of fine pores of a desired width, which is provided along the outer circumference of the printing pattern 2 and which is continuous to the printing pattern 2 over the flat surface end 5 from the vicinity of the periphery 6 towards inside of the plate substrate 4. This fine pattern 3 is continuous, for example, from slightly outside with a width of from about 0.5 to 2.0 mm (preferably from about 0.5 to 1.5 mm) of the above flat surface end 5 (from the vicinity of the periphery 6) to the printing pattern 2.

In the present invention, the flat surface does not include a chamfered portion, and the flat surface end is the boundary of the chamfer and the flat surface.

The screen printing plate of the present invention is characterized in that, in the above-described construction, the oil repellency against ink on the emulsion layer surface on the plate substrate 4 side of the above fine pattern 3 is set to be higher than the oil repellency against ink on the emulsion layer surface on the squeegee side of the fine pattern 3.

Such a screen printing plate is prepared by forming a photosensitive emulsion layer (hereinafter referred to as a non-oil repellent emulsion layer) on a well known screen printing base plate comprising a frame X and a screen mesh 1 set within the frame X, forming on one side of the photosensitive emulsion layer another photosensitive emulsion layer (hereinafter referred to also as an oil repellent emulsion layer) having a higher oil repellency against ink than the above photosensitive emulsion layer, followed by exposure and development by conventional methods to form the above-mentioned printing pattern 2 and the fine pattern 3. The screen printing base plate and the photosensitive emulsion to be used here, are not particularly limited and may be those which have been commonly used. As the non-oil repellent emulsion (the photosensitive emulsion to form the non-oil repellent emulsion layer) to be coated on the screen mesh, one commercially available under a tradename KV-800 (Kabushiki Kaisha Kurita Kagaku Kenkyusho) or under a tradename ACT COAT (Aicello Chemical Co., Ltd.) may be used in the present invention. The oil repellent emulsion (the photosensitive emulsion having a high oil repellency to form an oil repellent emulsion layer) may, for example, be a photosensitive emulsion containing an oil repellent material such as fluorine-type resin, and one commercially available under a tradename AS-395 (Oji Kakou K.K.) or under a tradename INT21 (Kabushiki Kaisha INT Screen) may, for example, be used in the present invention.

The printing pattern 2 and the fine pattern 3 may be formed by a method which is per se well known. For example, the printing pattern 2 and the fine pattern 3 can be formed by carrying out exposure and development by using a mask having the same patterns formed, which are in a positive/negative relation with these patterns. During the above screen printing plate making, at the region corresponding to the printing pattern 2, the majority of the photosensitive emulsion will be developed and removed, and the numerical aperture excluding the mesh body will be substantially 100% but is not required to be 100%, and it may be a numerical aperture whereby a printed layer having a desired thickness or a desired printing pattern can be formed on the plate substrate 4.

In the present invention, the numerical aperture means the proportion of an open area in a pattern comprising an area of an ink stopping portion by the emulsion layer and the open area other than the ink stopping portion, and it does not include the numerical aperture by the screen mesh.

One embodiment of the fine pattern 3 is shown in FIG. 2. As shown in FIG. 2, the fine pattern 3 is formed on a screen printing plate at a region corresponding to a width ranging from the vicinity of the periphery 6 of the plate substrate 4 inwardly to the printing pattern 2 over the flat surface end 5, and the width is not particularly limited, but, when the plate substrate 4 is the above-mentioned window glass for an automobile, a width of from about 1 to 2 mm, is preferred. Further, the numerical aperture of the fine pattern 3 is not particularly limited. However, for example, when printing is carried out by means of the above screen printing plate using an ink having a viscosity of from 25 to 100 Pa·s at 1.04 sec⁻¹, the numerical aperture is preferably from 55 to 85%, more preferably from 60 to 80%, taking into consideration prevention of mackling and dripping of ink onto the plate substrate 4.

FIG. 6 is an enlarged view of the fine pattern 3 in FIG. 2, wherein numeral 7 indicates a squeegee, numeral 8 an oil repellent emulsion layer formed on the surface on the plate substrate 4 side of the fine pattern 3 in a thickness of from 3 to 30 μm, preferably from 5 to 20 μm, for example 10 μm, and numeral 9 a non-oil repellent emulsion layer formed on the surface of the squeegee 7 side of the fine pattern 3 and within the screen mesh. The layer 9 is formed in a thickness of from 55 to 180 μm, preferably from 65 to 110 μm, for example 85 μm. These emulsion layers 8 and 9 may be set so that the oil repellency against ink on the surface on the plate substrate 4 side of the fine pattern is higher than the oil repellency against ink on the surface on the squeegee 7 side of the fine pattern 3, as mentioned above. For example, they may be formed so that the content of the oil repellent component such as a fluorine-type resin is larger in the oil repellent emulsion layer as compared with the non-oil repellent emulsion layer.

FIG. 7 is a partial enlarged plan view of a preferred embodiment of the fine pattern 3 of FIG. 6. This fine pattern 10 is a hexagonal pattern by a fine network line pattern having a width of 40 μm and a length of one side being 128 μm. The embodiment shown in the Figure is a preferred embodiment, and the fine pattern 3 may be of any shape such as a fine network line pattern or fine dots. However, with a view to prevention of mackling or prolonging the useful life of the screen printing plate, it is preferably constituted by a fine network line pattern, and the shape of the fine network line pattern may be any shape. When the permeability of ink to the plate substrate 4 at the portion inside of the flat surface end 5 of the plate substrate 4 and the ink-retaining property within the fine pattern 3 at a portion outside of the flat surface end 5 of the plate substrate 4, are taken into consideration, the shape of the fine network line pattern is preferably about circular.

Now, the printing method employing the above-mentioned screen printing plate of the present invention, will be described. The printing method of the present invention is a method wherein the above-mentioned screen printing plate 1 is accurately positioned on the plate substrate 4 to be printed, and then an ink is put on the screen printing plate and squeegeed by a squeegee to let the ink pass through the printing pattern 2 and the fine pattern 3 to form a desired printing layer corresponding to these patterns on the plate substrate 4. Such a printing operation itself may be a known method.

FIG. 8 is an enlarged cross-sectional view along line A-A in FIG. 1 in a state after a suitable ink 11 is printed. At a portion of the fine pattern 3 inside of the flat surface end 5 of the plate substrate 4, the ink is transferred to the plate substrate 4 through the printing pattern 2 and the fine pattern 3, and the ink is leveled on the plate substrate 4 and printed with the desired width and thickness to the flat surface end 5 of the plate substrate 4. On the other hand, at a portion of the fine pattern 3 outside of the flat surface end 5 of the plate substrate 4, no flat surface of the plate substrate 4 exists, and the ink 11 will be pooled in such a state as pushed out on the rear (substrate side) surface of the screen printing plate without being transferred to the surface of the plate substrate 4.

Here, the oil repellent emulsion layer 8 is formed on the surface of the fine pattern 3 on the plate substrate 4 side, and the ink 11 acts as repelled from the oil repellent emulsion layer 8, and further, a non-oil repellent emulsion layer 9 is formed on the surface of the fine pattern 3 on the squeegee side, and the ink 11 shows an affinity to the non-oil repellent emulsion layer 9. In this embodiment, the non-oil repellent emulsion layer 9 is formed also within the screen mesh of the fine pattern 3. Consequently, the ink 11 released from the pressing pressure by the squeegee will be held on the squeegee side surface of the fine pattern 3 and within the screen mesh of the fine pattern 3, whereby dripping of ink onto the plate substrate 4 will not occur even if the printing is repeated.

The above effects are obtainable not only in a case where the non-oil repellent emulsion layer 9 is formed over the entire thickness of the screen mesh as shown in FIG. 2, but also in a case where the thickness of the non-oil repellent emulsion layer 9 is thin, so long as the oil repellent emulsion layer 8 is formed on the plate substrate 4 side, for example, as shown in FIGS. 3 and 4. Further, as shown in FIG. 5, the non-oil repellent emulsion layer 9 may be formed on the screen mesh and may be formed so that the ink 11 shows an affinity to the non-oil repellent emulsion layer 9, as mentioned above.

FIGS. 11 and 12 show an embodiment of a screen printing plate which is capable of forming an accurate printed pattern also along a peripheral portion of a through-hole in a case where such a through-hole 13 is formed in a plate substrate such as a flat glass corresponding to the printing pattern 2 in the screen printing plate as shown in FIGS. 1 and 2, for attaching a member such as a wiper. The screen printing plate of this embodiment is characterized in that it has a fine pattern 3 in a region corresponding to a desired width ranging from slightly the hole center side of a flat surface end 15 at the above through-hole 13 to a flat surface on the side opposite to the hole center of the flat surface end, wherein emulsion layers 8 and 9 at the fine pattern are formed so that the oil repellency against ink on the surface on the plate substrate 4 side is higher than the oil repellency against ink on the surface on the squeegee side. Here, in the screen printing plate, the screen mesh corresponding to the through-hole 13 is sealed by an emulsion. Other constructions of the above screen printing plate and the method for making it are basically the same as the constructions of the above exemplified screen printing plate and the method for making it, and also the printing method employing such a screen printing plate is basically the same as described above.

In the present invention, it is possible to form a screen printing plate which is capable of printing to both flat surface ends of a plate substrate having a through-hole formed, i.e. the flat surface end at the through-hole and the flat surface end of the plate substrate.

FIG. 13 is a plan view showing a basic construction of a screen printing plate of the prior art, and FIG. 14 is an enlarged cross-sectional view taken along line A-A in a state before printing in FIG. 13. The printing pattern 2 of the screen printing plate is formed to extend outside of the flat surface end 5 of the plate substrate 4, taking into consideration irregularities of the outer shape of the plate substrate 4. FIG. 15 is an enlarged cross-sectional view taken along line A-A in a state after printing in FIG. 13. On the rear side of the screen printing plate corresponding to the portion outside of the flat surface end 5 of the plate substrate 4, ink 12 not transferred to the plate substrate 4 is pushed out, and the ink 12 sags and drips to the portion outside the flat surface end 5 of the plate substrate 4, as the printing is repeated, whereby the plate substrate 4 will be stained. As described in the foregoing, the present invention has solved such a problem.

In the foregoing, the characteristics of the present invention have been described, and in the present invention, the plate substrate to be printed is not particularly limited. However, the plate substrate which is particularly effective in the present invention is, for example, a window glass of an automobile, such as a front window glass, a rear window glass, a side window glass or a roof window glass. The ink to be used in the present invention is likewise not particularly limited. For example, any conventional ink may be used, which is an ink to be used for the purpose of preventing deterioration by ultraviolet rays of an urethane sealant supporting a window glass along its periphery or for the purpose of preventing e.g. terminals of electrical heating wires attached along the periphery of a glass plate from being seen through from outside of the car, and which is baked along the peripheral portion of the glass plate to form a colored non-transparent layer. For example, an ink comprising from 10 to 30 mass% of a black pigment (such as copper chromate), from 45 to 65 mass% of glass frits, from 0 to 10 mass% of a refractory filler, from 1 to 10 mass% of a resin (such as ethyl cellulose) and from 5 to 20 mass% of a solvent (a-terpineol) may be mentioned.

Now, the present invention will be described in further detail with reference to Examples. However, it should be understood that the present invention is by no means restricted by such specific Examples.

### EXAMPLE 1

Preparation of a Screen Printing Plate

A non-oil repellent emulsion (containing no fluorine resin) was coated in a substantially uniform thickness (about 85 μm) within a screen mesh (a screen mesh made of Tetron fibers with 180 mesh) from the surface on the squeegee side of a screen printing base plate set within a screen frame to the surface on the plate substrate side, and dried, and then on the upper surface of the non-oil repellent emulsion layer on the surface of the plate substrate side, an oil repellent emulsion (containing a fluorine resin) was coated in a thickness of about 10 μm and dried to obtain a screen printing base plate. On the other hand, a mask having the same pattern formed, which is in a positive/negative relation with a pattern comprising a fine pattern 3 by a hexagonal fine line having a width of 40 μm, a length per side of 128 μm and a numerical aperture of 67% and a desired printing pattern 2, was prepared. Using the above screen printing base plate and the mask, exposure and development were carried out by conventional methods for screen printing plate making to obtain a screen printing plate of the present invention. Here, the fine pattern 3 was formed outside the printing pattern 2 from a position inside of the flat surface end 5 of the plate substrate 4 by about 0.5 mm to a position departing outwardly with a width of about 1.5 mm (to the vicinity of the periphery 6 of the plate substrate 4) (i.e. the fine pattern 3 is formed from a position of about 1.0 mm outside to a position of about 0.5 mm inside, based on the flat surface end 5).

### EXAMPLE 2

Preparation of a Screen Printing Plate

A non-oil repellent emulsion (containing no fluorine resin) was coated in a substantially uniform thickness (about 85 μm) within a screen mesh (a screen mesh made of Tetron fibers with 180 mesh) from the surface on the squeegee side of the screen printing base plate set within the screen frame to the surface on the plate substrate side, and dried, and then on the upper surface of the non-oil repellent emulsion layer on the surface of the plate substrate side, an oil repellent emulsion (containing a fluorine resin) was coated in a thickness of about 10 μm and dried to obtain a screen printing base plate. On the other hand, a mask having the same pattern formed, which was in a positive/negative relation with a pattern comprising a fine pattern 3 by fine dots having a diameter of 85 μm and a numerical aperture of 67% and a desired printing pattern 2, was prepared. Using the above screen printing base plate and the mask, exposure and development were carried out by conventional methods for screen printing plate making to obtain a screen printing plate of the present invention. Here, the fine pattern 3 was formed outside the printing pattern 2 from a position inside of the flat surface end 5 of the plate substrate 4 by about 0.5 mm to a position departing outwardly with a width of about 1.5 mm (to the vicinity of the periphery 6 of the plate substrate 4) (i.e. the fine pattern 3 is formed from a position of about 1.0 mm outside to a position of about 0.5 mm inside, based on the flat surface end 5).

### EXAMPLE 3

Printing was carried out on 50 sheets of flat glass using the screen printing plate made in the above Example 1 and a screen printing plate (Comparative Example) of the prior art (FIG. 14) and using an ink having a viscosity of 40 Pa·s at 1.04 sec⁻¹ (the composition was as shown below). The amount (thickness) of the ink pushed out on the rear surface of the screen printing plate at the portion outside of the flat surface end 5 of the flat glass, at that time, is shown in FIG. 9.

Ink composition

| | |
|---|---|
| Black pigment (Cu-Cr-Mn-O type) | 20 mass % |
| Glass frit | 55 mass % |
| Refractory filler (Al₂O₃) | 4 mass % |
| Resin (ethyl cellulose) | 2 mass % |
| Solvent (α-terpineol) | 19 mass % |

Here, the mesh of the screen printing plate 1 of the prior art was a screen mesh made of Tetron fibers with 180 mesh. Further, the printing pattern 2 was formed to extend to the vicinity of the periphery 6 of the plate substrate 4, which was outwardly apart with a width of about 1.0 mm from the flat surface end 5 of the plate substrate 4. Further, the non-oil repellent emulsion was coated in a thickness of about 95 μm ranging from the surface on the squeegee side of the screen printing plate 1 to the thickness of 10 μm on the surface on the plate substrate side.

As compared with an example where the conventional screen printing plate was employed, in an example where the screen printing plate of the present invention was employed, the amount of ink pushed out on the rear surface of the screen printing plate was small, and after the 20th sheet, no change was observed in the amount of ink pushed out, even if the printing was repeated, and no dripping of ink onto the flat glass took place. On the other hand, in an Example wherein the conventional screen printing plate was employed, the pool of the ink increased in proportion to the number of printed sheets, and dripping of ink occurred.

### EXAMPLE 4

In the preparation of a screen printing plate in the above Example 1, the numerical aperture of the fine pattern was changed as shown in the following Table 1 to prepare a plurality of screen printing plates. Using these plates and using an ink having the same viscosity of 40 Pa·s at 1.04 sec⁻¹ as in Example 3, printing was carried out on 50 sheets of flat glass, respectively. The print qualities of flat glass obtained by this printing (mackling at the portion inside of the flat surface end of flat glass, and dripping of ink at the portion outside of the flat surface end of the flat glass) are shown in the following Table 1. As shown in Table 1, in order to secure flat glass having a constant print qualities, for example, when an ink having a viscosity of 40 Pa·s at 1.04 sec⁻¹ is used, the numerical aperture of the fine pattern is preferably from 55 to 85%.

TABLE 1
Numerical aperture of the fine pattern and print qualities

| Print | Numerical aperture of the fine pattern (%) | | | | | | | | | | |
|---|---|---|---|---|---|---|---|---|---|---|---|
| qualities | 45 | 50 | 55 | 60 | 65 | 70 | 75 | 80 | 85 | 90 | 95 |
| Mackling | X | X | ◯ | ◯ | ◯ | ◯ | ◯ | ◯ | ◯ | ◯ | ◯ |
| Dripping of ink | ◯ | ◯ | ◯ | ◯ | ◯ | ◯ | ◯ | ◯ | ◯ | X | X |
| onto flat glass | | | | | | | | | | | |

◯: No mackling or no dripping of ink observed.
X: Hackling or dripping of ink observed.

### EXAMPLE 5

Using the screen printing plates of the above Examples 1 and 2 and using an ink having the same viscosity of 40 Pa·s at 1.04 sec⁻¹ as in Example 3, printing was carried out on 50 sheets of flat glass, respectively. At that time, using a plurality of screen printing plates having the numerical aperture of the fine pattern changed within a range of from 55 to 85%, respectively, printing was carried out on flat glass. The print quality (mackling at the portion inside of the flat surface end of the flat glass) of the obtained flat glass is shown in the following Table 2. In a case where the screen printing plate of Example 1 was used, the width to be masked by the fine network line pattern was narrow as compared with the case where the screen printing plate of Example 2 having fine dots having a diameter of 85 μm, whereby the ink was readily leveled on the flat glass, and mackling scarcely occurred. Further, in the case of a screen printing plate having fine dots, if the fine dot diameter is made small, the fine dots tend to be susceptible to abrasion and falling off from the mesh, and thus influence the useful life of the screen printing plate. It is evident from Table 2 that when a fine network line pattern is employed as the fine pattern, good results are obtainable within a wide range of the numerical aperture, but when fine dots are employed as the fine pattern, a numerical aperture of at least 80% is preferred.

TABLE 2
The shape of the fine pattern and the print quality

| | | Numerical aperture of the | | | | | | |
|---|---|---|---|---|---|---|---|---|
| Print | Shape of fine | fine pattern (%) | | | | | | |
| quality | pattern | 55 | 60 | 65 | 70 | 75 | 80 | 85 |
| Mackling | Hexagonal fine | ◯ | ◯ | ◯ | ◯ | ◯ | ◯ | ◯ |
| | network line pattern | | | | | | | |
| | (line width: 40 μm) | | | | | | | |
| | Fine dots | X | X | X | X | X | ◯ | ◯ |
| | (diameter: 85 μm) | | | | | | | |

### EXAMPLE 6

Using the screen printing plates of the above Examples 1 and 2 and the ink in Example 3, printing was carried out on 5,000 sheets of flat glass, respectively, whereupon the remaining ratio of the fine pattern of each screen printing plate was examined by means of a microscope under 100 magnifications, and the results are shown in FIG. 10. The results show that as opposed to fine dots whereby the respective dots will independently engage with the screen mesh, respectively, with the fine network line pattern, the pattern is not in the form of dots but a continuous pattern, whereby abrasion or falling off of the emulsion due to friction with the flat glass during printing scarcely occurs, and the useful life of the screen printing plate is improved. Accordingly, in the present invention, the fine pattern may be one made of fine dots, but it is evident that the fine network line pattern is preferred to the fine dots.

### EXAMPLE 7

Using the screen printing plate of Example 1 and the ink of Example 3, printing was carried out on 5,000 sheets of flat glass, whereby it was possible to carry out continuous printing extending to the flat surface end of the flat glass. During the printing, no dripping of ink occurred at the portion outside of the flat surface end of flat glass, and no mackling occurred at the portion inside of the flat surface end of flat glass, whereby good printing quality was secured. Further, upon completion of the printing of 5,000 sheets, the fine pattern portion of the screen printing plate was examined by a microscope with 100 magnifications, whereby at least 80% of the fine pattern was maintained, and thus it was confirmed that adequate useful life of the screen printing plate was secured.

### EXAMPLE 8

Another embodiment of the screen printing plate of the present invention is shown in FIG. 11 (a plan view of the screen printing plate) and in FIG. 12 (showing the state after printing) which is an enlarged cross-sectional view along line A-A in FIG. 11. As shown in FIGS. 11 and 12, the screen printing plate of the present invention was prepared in the same manner as in Example 1 except that the fine pattern 3 was formed adjacent to the printing pattern 2, a width of about 1.5 mm from a position of about 0.5 mm on the side opposite to the hole center, based on the position of the flat surface end 14 in the through-hole 13 of flat glass 4 to a position apart towards the hole center side (in the vicinity of the periphery 15 of the through-hole) (i.e., the fine pattern 3 was formed from a position on the hole center side by about 1.0 mm to a position on the side opposite to the hole center by about 0.5 mm, based on the flat surface end 14).

### EXAMPLE 9

Using the screen printing plate made in Example 8 and the ink of Example 3, printing was carried out on flat glass 4, whereby it was possible to carry out the printing extending to the flat surface end 14 of the hole 13 of the flat glass 4. Here, at the portion on the hole center side of the flat surface end 14, the ink 11 was maintained on the surface on the squeegee side of the fine pattern 3 and within the screen mesh of the fine pattern 3, and no dripping of the ink 11 occurred, and no mackling occurred at the portion on the side opposite to the hole center from the flat surface end 14. Thus printing was carried out in good quality.

As described in the foregoing, the present invention provides excellent effects that printing can easily be carried out extending to the flat surface end of a plate substrate such as flat glass without ink dripping. Further, with a construction having a proper numerical aperture, an effect for prevention of mackling can be obtained.

Further, when the fine pattern is constituted by a fine network line pattern, it is also possible to obtain the effects for preventing mackling and improving the useful life of the screen printing plate.

Further, even in a case where a through-hole is formed on a plate substrate, printing can easily be carried out extending to the flat surface end around the through-hole without ink dripping, as mentioned above. Further, by adopting a specific fine pattern, printing can be carried out in a constant quality without mackling.

The entire disclosure of Japanese Patent Application No. 2000-117597 filed on Apr. 19, 2000 including specification, claims, drawings and summary are incorporated herein by reference in its entirety.

What is claimed is:

1. A screen printing plate made to carry out printing along a peripheral portion of a plate substrate, which screen printing plate has a fine pattern at a region corresponding to a desired width ranging from slightly outside of a flat surface end of the plate substrate to a flat surface inside of the flat surface end, wherein an emulsion layer at the fine pattern is formed to have a higher oil repellency against ink on the surface on the plate substrate side than the oil repellency against ink on the surface on the squeegee side.

2. The screen printing plate according to claim 1, wherein the fine pattern is constituted by a fine network line pattern.

3. A method for making a screen printing plate to carry out printing along a peripheral portion of a plate substrate, which comprises forming a photosensitive emulsion layer on a screen printing base plate, forming on one side of the photosensitive emulsion layer another photosensitive emulsion layer having a higher oil repellency against ink than the above photosensitive emulsion layer, followed by exposure and development by conventional methods to form a printing pattern, wherein at least a part of the printing pattern is formed in the form of a fine pattern at a region corresponding to a desired width ranging from slightly outside of a flat surface end of the plate substrate to a flat surface inside of the flat surface end, wherein the emulsion layer at the fine pattern is formed to have a higher oil repellency against ink on the surface on the plate substrate side than the oil repellency against ink on the surface on the squeegee side.

4. A screen printing method which comprises carrying out printing along a peripheral portion of a plate substrate by using a screen printing plate and an ink, wherein the screen printing plate is a screen printing plate as defined in claim 1.

5. The screen printing method according to claim 4, wherein the plate substrate is a window glass for an automobile.

6. The screen printing method according to claim 4, wherein the ink is an ink having a viscosity of from 25 to 100 Pa·s at 1.04 sec⁻¹.

7. A screen printing plate made to carry out printing along a peripheral portion of a through-hole of a plate substrate having such a through-hole within a flat surface, which screen printing plate has a fine pattern at a region corresponding to a desired width ranging from slightly the hole center side of a flat surface end of the plate substrate to a flat surface on the side opposite to the hole center of the flat surface end, wherein an emulsion layer at the fine pattern is formed to have a higher oil repellency against ink on the surface on the plate substrate side than the oil repellency against ink on the surface on the squeegee side.

8. The screen printing plate according to claim 7, wherein the fine pattern is constituted by a fine network line pattern.

9. A method for making a screen printing plate to carry out printing along a peripheral portion of a through-hole of a plate substrate having such a through-hole within a flat surface, which comprises forming a photosensitive emulsion layer on a screen printing base plate, forming on one side of the photosensitive emulsion layer another photosensitive emulsion layer having a higher oil repellency against ink than the above photosensitive emulsion layer, followed by exposure and development by conventional methods to form a printing pattern, wherein at least a part of the printing pattern is formed in the form of a fine pattern at a region corresponding to a desired width ranging from slightly the hole center side of a flat surface end of the plate substrate to the flat surface on the side opposite to the hole center of the flat surface end, wherein an emulsion layer at the fine pattern is formed to have a higher oil repellency against ink on the surface on the plate substrate side than the oil repellency against ink on the surface on the squeegee side.

10. A screen printing method which comprises carrying out printing along a peripheral portion of a through-hole of a plate substrate having such a through-hole within a flat surface by using a screen printing plate and an ink, wherein the screen printing plate is a screen printing plate as defined in claim 7.

11. The screen printing method according to claim 10, wherein the plate substrate is a window glass for an automobile.

12. The screen printing method according to claim 10, wherein the ink is an ink having a viscosity of from 25 to 100 Pa·s at 1.04 sec⁻¹.
